(19) United States
(12) Patent Application Publication
(10) Pub. No.: US 2014/0328018 A1
(43) Pub. Date: Nov. 6, 2014

(54) FANLESS NOTEBOOK COMPUTER STRUCTURE PROVIDING ENHANCED GRAPHICS PERFORMANCE AND FORM FACTOR

(71) Applicant: NVIDIA CORPORATION, Santa Clara, CA (US)

(72) Inventor: William Tsu, Santa Clara, CA (US)

(73) Assignee: Nvidia Corporation, Santa Clara, CA (US)

(21) Appl. No.: 13/886,685

(22) Filed: May 3, 2013

(51) Int. Cl. G06F 1/16

(52) U.S. Cl. CPC G06F 1/1615
USPC 361/679.54; 29/592.1

(57) ABSTRACT

A notebook computer includes a lower notebook portion that provides a fanless environment having a keyboard and supplemental electronics. Additionally, the notebook computer also includes an upper notebook portion that provides an additional fanless environment having a display and a processing unit, wherein the processing unit includes a general purpose CPU and an integrated GPU configured to operate in the additional fanless environment. Another notebook computer includes a fanless lower notebook body that has a keyboard and a discrete GPU and a fanless upper notebook body that has a display and a general purpose CPU with an integrated GPU, wherein the discrete GPU is configured to augment the integrated GPU. A method of manufacturing a notebook computer is also provided.

### TECHNICAL FIELD

This application is directed, in general, to computing and, more specifically, to a notebook computer, another notebook computer and a method of manufacturing a notebook computer.

### BACKGROUND

In current notebook computers, the central processing unit (CPU) and graphics processing unit (GPU) reside in the base dock under the keyboard. For enhanced performance capability, the power dissipation required by the CPU and GPU is high, thereby requiring active fan cooling to accommodate this heat dissipation. The use of active fan cooling entails several disadvantages that include fan noise and vibration, shorter battery runtime and a larger form factor for the notebook. The fan speed in some notebook fans has been increased to provide additional air movement thereby increasing at least fan noise. Some computer technologies combine the use of discrete graphics with integrated graphics capabilities to enhance performance, thereby exacerbating the heat management problem. What is needed in the art is a way to better manage performance related heat issues.

### SUMMARY

Embodiments of the present disclosure provide a notebook computer, a method of manufacturing a notebook computer and another notebook computer.

In one embodiment, the notebook computer includes a lower notebook portion that provides a fanless environment having a keyboard and supplemental electronics. Additionally, the notebook computer also includes an upper notebook portion that provides an additional fanless environment having a display and a processing unit, wherein the processing unit includes a general purpose CPU and an integrated GPU configured to operate in the additional fanless environment.

In another aspect, the method of manufacturing a notebook computer includes providing fanless bottom and top cases of the notebook computer. The method also includes installing a keyboard and supplemental electronics into the fanless bottom case and installing a display and a general purpose CPU with integrated GPU into the fanless top case. The method further includes interconnecting the keyboard, the display, the general purpose CPU with integrated GPU and the supplemental electronics.

In yet another aspect, another notebook computer includes a fanless lower notebook body that has a keyboard and a discrete GPU. The another notebook computer also includes a fanless upper notebook body that has a display and a general purpose CPU with an integrated GPU, wherein the discrete GPU is configured to augment the integrated GPU.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

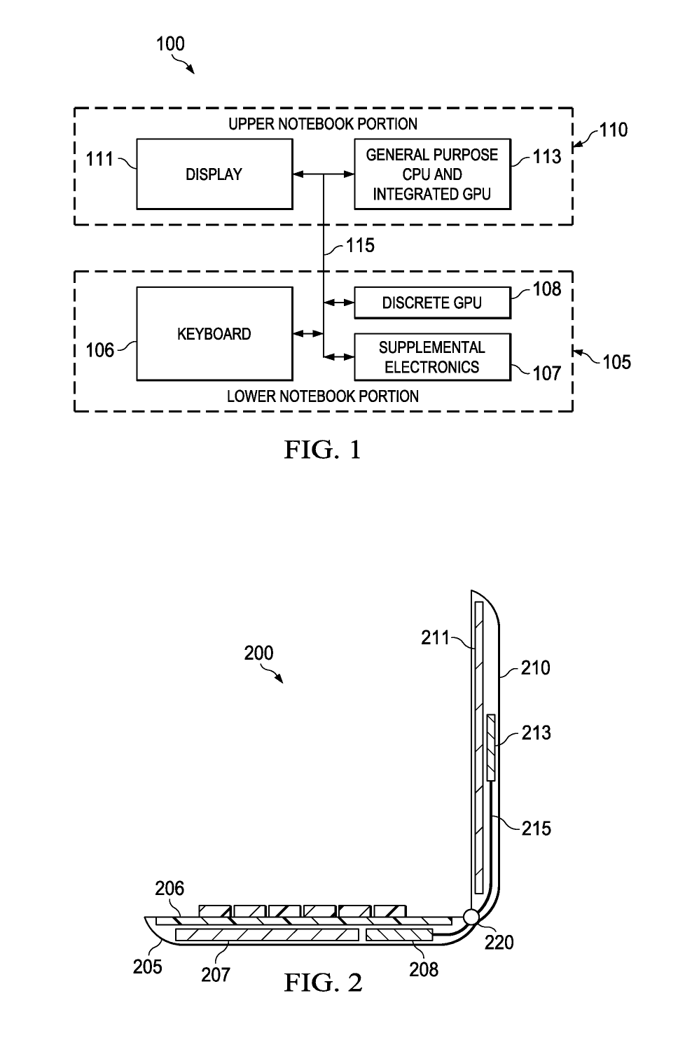

FIG. 1 illustrates a functional block diagram of a notebook computer constructed according to the principles of the present disclosure;

FIG. 2 illustrates a sectioned side view of a notebook computer constructed according to the principles of the present disclosure; and

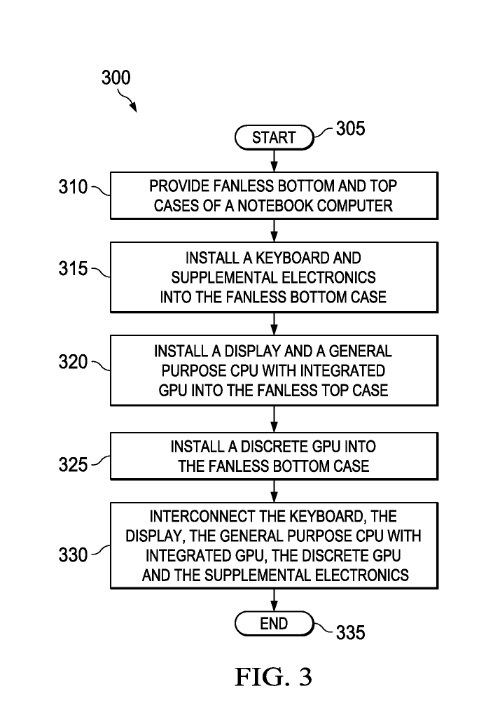

FIG. 3 illustrates a flow diagram of an embodiment of a method of manufacturing a notebook computer carried out according to the principles of the present disclosure.

### DETAILED DESCRIPTION

Embodiments of the present disclosure provide a novel system architecture that enables a passively cooled, fanless notebook structure, while achieving enhanced graphics performance in a thinner and lighter form factor. For purposes of the present disclosure, the term “notebook computer” is defined to be inclusive of the terms portable computer, laptop computer or netbook computer, for example.

FIG. 1 illustrates a functional block diagram of a notebook computer, generally designated 100, constructed according to the principles of the present disclosure. The notebook computer 100 includes a lower notebook portion 105, an upper notebook portion 110 and an interconnecting cable 115. The lower notebook portion 105 provides a fanless environment and includes a keyboard 106, supplemental electronics 107 and a discrete graphics processing unit (GPU) 108. The upper notebook portion 110 provides an additional fanless environment and includes a display 111 and a notebook processing unit consisting of a general purpose computer processing unit (CPU) having an integrated GPU 113. All of the above identified notebook elements are selected and configured to operate properly in the fanless environments of the lower and upper notebook portions.

In the illustrated embodiment, operation of the notebook processing unit is enhanced since it includes not only the general purpose CPU and integrated GPU 113 but additionally includes the discrete GPU 108. Here, the discrete GPU may be continuously powered-up with the general purpose CPU and integrated GPU 113. Alternately, the discrete GPU may be powered-up on an intermittent basis to augment operation of the general purpose CPU and integrated GPU 113. In other embodiments, the discrete GPU 108 is not included in the notebook processing unit 100, which employs only the general purpose CPU and integrated GPU 113.

The keyboard 106 provides for data entry and word processing applications. The supplemental electronics 107 includes required additional memory as well as support electronics for operation of the identified notebook elements and peripheral features. The display 111 offers a resolution, response time and power dissipation consistent with the fanless environment. The general purpose CPU and integrated GPU 113 are selected and configured to operate in the upper notebook portion 110. Correspondingly, the discrete GPU 108 is selected and configured to operate in the fanless environment of the lower notebook portion 105 to provide the expanded and enhanced performance capabilities for the integrated GPU.

In the illustrated embodiment, the general purpose CPU and integrated GPU provide a power dissipation of less five watts, which is acceptable in the fanless environment of the upper notebook portion 110. Additionally, the discrete GPU provides a power dissipation of less than 10 watts, which is also acceptable in the fanless environment of the lower notebook portion 105. Selection of each of these power dissipations is dependent on a maximum allowable power dissipation afforded by each of the fanless environments of the lower and upper notebook portions 105, 110. In order to decrease average power dissipation in the lower notebook portion 105, the discrete GPU 108 may be powered-down when the fanless environment of the lower notebook portion 105 reaches a preset maximum temperature.

The interconnecting cable 115 is employed to interconnect the keyboard 106, display 111, general purpose CPU with integrated GPU 113, discrete GPU 108 and supplemental electronics 107 to provide required operations of the notebook computer 100. In one embodiment, a peripheral component interconnect express connection (PCIe) is employed between at least a portion of these notebook elements for their interconnection.

FIG. 2 illustrates a sectioned side view of a notebook computer, generally designated 200, constructed according to the principles of the present disclosure. The notebook computer 200 includes a fanless bottom case 205 and a fanless top case 210. The fanless bottom case 205 includes a keyboard 206, supplemental electronics 207 and a discrete GPU 208. The fanless top case 210 includes a display 211 and a general purpose CPU with integrated GPU 213. Also shown in the bottom and top cases 205, 210 is a portion of an interconnecting cable 215, employing a hinge connector 220, between the general purpose CPU with integrated GPU 213 and the discrete GPU 208. The notebook computer 200 corresponds functionally to the description of FIG. 1.

The notebook computer 200 provides a general example of how components of a fanless notebook, constructed according to the principles of the present disclosure, may be assembled or arranged during a manufacturing process. Here, the portion of the interconnecting cable 215 between the discrete GPU and the integrated GPU employs a peripheral component interconnect express (PCIe) connection. Additionally, although not expressly shown, some of the keyboard 206, display 211, general purpose CPU with integrated GPU 213 and supplemental electronics 207 may also be interconnected employing PCIe connections. Alternately, other interconnection approaches may be used.

In some embodiments, at least one of the fanless bottom and top cases 205, 210 is thermally conductive and may be employed as a heat sink. In this case, at least one of the discrete GPU 208 and the general purpose CPU with integrated GPU 213 may be assembled to allow heat sinking to its corresponding case.

FIG. 3 illustrates a flow diagram of an embodiment of a method of manufacturing a notebook computer, generally designated 300, carried out according to the principles of the present disclosure. The method 300 starts in a step 305, and fanless bottom and top cases of a notebook computer are provided in a step 310. Then, in a step 315, a keyboard and supplemental electronics are installed into the fanless bottom case, and a display and a general purpose CPU with integrated GPU are installed into the fanless top case, in a step 320. In the illustrated embodiment, a discrete GPU is also installed into the fanless bottom case, in a step 325. The keyboard, the display, the supplemental electronics, the general purpose CPU with integrated GPU and the discrete GPU are interconnected, in a step 330.

In one embodiment, the discrete GPU and integrated GPU are interconnected with a peripheral component interconnect express connection. In another embodiment, at least a portion of the keyboard, display, general purpose CPU with integrated GPU and supplemental electronics are interconnected using peripheral component interconnect express connections. In yet another embodiment, the peripheral component interconnect express connections employ a connector between the fanless bottom and top cases of the notebook computer. In still another embodiment, the fanless bottom and top cases are thermally conductive and respectively employed as a heat sink for at least one of the discrete GPU and the general purpose CPU with integrated GPU. In a further embodiment, the discrete GPU is powered-down when the fanless bottom case reaches a predetermined maximum temperature. The method 300 ends in a step 335.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A notebook computer, comprising:
a lower notebook portion that provides a fanless environment and includes a keyboard and supplemental electronics; and
an upper notebook portion that provides an additional fanless environment and includes a display and a processing unit; wherein the processing unit includes a general purpose CPU and an integrated GPU configured to operate in the additional fanless environment.

2. The notebook computer as recited in claim 1 further comprising a discrete GPU located within the lower notebook portion and configured to operate in the fanless environment to augment the integrated GPU.

3. The notebook computer as recited in claim 2 wherein the discrete GPU and the integrated GPU are coupled together by a peripheral component interconnect express connection.

4. The notebook computer as recited in claim 2 wherein the discrete GPU provides an average power dissipation of less than 10 watt.

5. The notebook computer as recited in claim 2 wherein the discrete GPU is powered-up on an intermittent basis to augment operation of the integrated GPU.

6. The notebook computer as recited in claim 2 wherein the discrete GPU is powered-down when the fanless environment of the lower notebook portion reaches a predetermined maximum temperature.

7. The notebook computer as recited in claim 1 wherein the general purpose CPU and integrated GPU provide a power dissipation of less than five watts.

8. The notebook computer as recited in claim 1 wherein the keyboard, display, general purpose CPU with integrated GPU and supplemental electronics are interconnected to provide required operations of the notebook computer.

9. The notebook computer as recited in claim 1 wherein at least a portion of the keyboard, display, general purpose CPU with integrated GPU and supplemental electronics is interconnected using peripheral component interconnect express connections.

10. The notebook computer as recited in claim 9 wherein the peripheral component interconnect express connections employ a connector between the lower and upper notebook portions.

11. A method of manufacturing a notebook computer, comprising:
providing fanless bottom and top cases of the notebook computer;
installing a keyboard and supplemental electronics into the fanless bottom case;
installing a display and a general purpose CPU with integrated GPU into the fanless top case; and
interconnecting the keyboard, the display, the general purpose CPU with integrated GPU and the supplemental electronics.

12. The method as recited in claim 11 further comprising installing a discrete GPU into the fanless bottom case that is interconnected with the integrated GPU.

13. The method as recited in claim 12 wherein the discrete GPU and integrated GPU are interconnected with a peripheral component interconnect express connection.

14. The method as recited in claim 12 wherein at least one of the fanless bottom and top cases is thermally conductive and respectively employed as a heat sink for at least one of the discrete GPU and the general purpose CPU with integrated GPU.

15. The method as recited in claim 11 wherein at least a portion of the keyboard, display, general purpose CPU with integrated GPU and supplemental electronics is interconnected using a peripheral component interconnect express connection.

16. The method as recited in claim 15 wherein the peripheral component interconnect express connection employs a connector between the fanless bottom and top cases of the notebook computer.

17. Another notebook computer, comprising:
a fanless lower notebook body that includes a keyboard and a discrete GPU; and
a fanless upper notebook body that includes a display and a general purpose CPU with an integrated GPU, wherein the discrete GPU is configured to augment the integrated GPU.

18. The notebook computer as recited in claim 17 wherein the keyboard, display, general purpose CPU with integrated GPU and discrete GPU are interconnected.

19. The notebook computer as recited in claim 17 wherein at least a portion of the keyboard, display, general purpose CPU with integrated GPU and discrete GPU is interconnected using a peripheral component interconnect express connection.

20. The notebook computer as recited in claim 17 wherein at least a portion of the keyboard, display, general purpose CPU with integrated GPU and discrete GPU is interconnected employing a connector between the fanless lower notebook body and the fanless upper notebook body.
